(19) United States
(12) Patent Application Publication
(10) Pub. No.: US 2026/0087618 A1
(43) Pub. Date: Mar. 26, 2026

(54) IMAGE CLASSIFICATION USING MACHINE LEARNING INCLUDING WEAKLY-LABELED DATA

(71) Applicant: Ohio State Innovation Foundation, Columbus, OH (US)

(72) Inventors: Asmaa ALJUHANI, Columbus, OH (US); Raghu MACHIRAJU, Columbus, OH (US); Jany CHAN, Westerville, OH (US); David LIEBNER, Westerville, OH (US); Ishya CASUKHELA, Lima, OH (US)

(21) Appl. No.: 19/111,030

(22) PCT Filed: Sep. 15, 2023
(86) PCT No.: PCT/US2023/032914

§ 371 Date: Mar. 12, 2025

Related U.S. Application Data
(60) Provisional application No. 63/375,921, filed on Sep. 16, 2022.

(51) Int. Cl. G06T 7/00; G06V 10/764; G06V 10/82

(52) U.S. Cl. CPC G06T 7/0012; G06V 10/764; G06V 10/82; G06T 2207/20081

(57) ABSTRACT

A system may receive a plurality of digital histology images, wherein each of the plurality of digital histology images is labeled with a respective image-level classification. A system may extract a plurality of tiles from each of the plurality of digital histology images. A system may create a first dataset comprising the plurality of tiles and respective image-level classifications. A system may train a first machine learning model using the first dataset. A system may create a second dataset by sampling the first dataset based on respective classifications and respective uncertainty measures for each of the plurality of tiles output by the trained first machine learning model. A system may train a second machine learning model using the second dataset, wherein the trained second machine learning model is configured to classify one or more tiles of a digital histology image.

### CROSS-REFERENCE TO RELATED APPLICATIONS

This application claims the benefit of U.S. provisional Ser. No. 63/375,921, filed on Sep. 16, 2022, and titled “HISTOLOGY IMAGE CLASSIFICATION USING MACHINE LEARNING AND RELATED TRAINING METHODS INCLUDING UNCERTAINTY AWARE SAMPLING OF WEAKLY-LABELED DATA,” the disclosure of which is expressly incorporated herein by reference in its entirety,

### BACKGROUND

Whole slide images (WSI) are increasingly used in pathology labs for diagnosing and monitoring diseases, including cancer. Diagnosis of WSI-level labels can be obtained from clinical data which are readily available from patient records. However, associated WSIs are very large, and there is limited notation as to which regions within them explain the WSI-level diagnosed label. More often than not, a WSI with an accorded label includes several regions associated with other labels of diagnostic severity, as well as normal tissue and other artifacts.

This incongruence is even more remarkable for certain complex cancers, like soft tissue sarcomas (STS) which are a rare group of aggressive cancers that account for one percent of the overall malignant tumors in adults. They are highly heterogeneous with more than 89 subtypes. Each subtype is manifested by distinct histological, molecular, and specific clinical characteristics [7], which poses significant challenges to pathologists in terms of annotation effort and accuracy.

The current gold standard for diagnosis of STS cases relies on a pathologist-assigned tumor grade using the French National Federation of Cancer Centers (FNCLCC) system [24]. Pathologists visually inspect H&E stained tissue under a high-power microscope to determine cancerous regions while avoiding non-relevant regions and other artifacts. A diagnosis grade 1-3 (3 being most severe, 1 being the least) is then assigned by the aggregate score of tumor differentiation, necrosis, and mitotic rate.

Deep learning, particularly weakly supervised learning approaches that utilize only WSI-level labels, has had success with handling segmentation and classification [3, 17, 21]. These methodologies, however, depend on several thousands of WSIs to achieve performance comparable to supervised approaches. Promising results have been reported by assigning the same WSI-level label to all tiles (often square regions) [10]. However, not all tiles are equally representative of the assigned WSI label, generating noisy training labels that degrade the performance of deep learning models. Consequently, errors in diagnoses in addition to noise from pre-processing will accumulate and hinder the inferential and predictive performance of models.

Thus, there is a need for reliable and accurate deep learning approaches capable of identifying relevant tiles from a large WSI as well as providing a measure of uncertainty for its prediction.

### SUMMARY

Systems and methods for training a machine learning model using weakly-labeled digital histology images are described herein. In some implementations, a plurality of digital histology images are received, and a plurality of tiles are extracted from the digital histology images. A dataset including the plurality of tiles is created. The dataset is weakly labeled because each of the plurality of tiles is labeled with a respective image-level classification associated with its respective digital pathology image. A machine learning model is trained using the dataset and then used to output a respective classification and a respective uncertainty measure for each of the plurality of tiles in the dataset. Thereafter, the dataset is sampled based on the output of the trained machine learning model such that diagnostically relevant tiles among the plurality of tiles are included in a modified dataset. Finally, a machine learning model is trained using the modified dataset.

Systems and methods for classifying one or more tiles of a digital histology image using a machine learning model are also described herein. In some implementations, a machine learning model is deployed. Additionally, a digital histology image is received, and a plurality of tiles are extracted from the digital histology image. Thereafter, the plurality of tiles are input into the deployed machine learning model, and the deployed machine learning model outputs both a respective classification and a respective uncertainty measure for each of the plurality of tiles.

An example computer-implemented method for training a machine learning model is described herein. The method includes receiving a plurality of digital histology images, where each of the plurality of digital histology images is labeled with a respective image-level classification; and extracting a plurality of tiles from each of the plurality of digital histology images, where each of the plurality of tiles is labeled with a respective image-level classification associated with its respective digital pathology image. The method also includes creating a first dataset including the plurality of tiles and the respective image-level classifications; and training a first machine learning model using the first dataset. The trained first machine learning model is configured to output a respective classification and a respective uncertainty measure for each of the plurality of tiles. The method further includes creating a second dataset by sampling the first dataset based on the respective classifications and the respective uncertainty measures output by the first machine learning model; and training a second machine learning model using the second dataset. The trained second machine learning model is configured to classify one or more tiles of a digital histology image.

Additionally, the second dataset includes a subset of the plurality of tiles of the first dataset. For example, the subset of the plurality of tiles of the first dataset includes the most diagnostically relevant tiles among the plurality of tiles of the first dataset.

Alternatively, or additionally, the step of creating the second dataset by sampling the first dataset includes identifying one or more of the plurality of tiles of the first dataset having relatively high predictive probability and relatively low uncertainty. For example, the one or more of the plurality of tiles of the first dataset having relatively high predictive probability and relatively low uncertainty are identified using a threshold value for predictive probability and uncertainty.

Alternatively, or additionally, the first machine learning model is a deep learning model. Optionally, the deep learning model is a convolutional neural network (CNN). The CNN can include a plurality of fully connected layers and a plurality of dropout layers, where each of the plurality of dropout layers corresponds to a respective fully connected layer.

In some implementations, the step of training the first machine learning model using the first dataset includes inputting the first dataset into the CNN; and processing, using the CNN, the first dataset to minimize or maximize an objective function for the CNN. Additionally, the step of training the first machine learning model using the first dataset further includes inputting the first dataset into the CNN; predicting, using the CNN, the respective classifications for each of the plurality of tiles; and obtaining the respective uncertainty measures for each of the plurality of tiles. Optionally, the step of obtaining the respective uncertainty measures for each of the plurality of tiles includes using a Monte Carlo simulation.

Alternatively, or additionally, the second machine learning model is a deep learning model. Optionally, the deep learning model is a convolutional neural network (CNN). The CNN can include a plurality of fully connected layers and a plurality of dropout layers, where each of the plurality of dropout layers corresponds to a respective fully connected layer.

In some implementations, the step of training the second machine learning model using the second dataset includes inputting the second dataset into the CNN; and processing, using the CNN, the second dataset to minimize or maximize an objective function for the CNN.

Alternatively, or additionally, the digital histology images are whole slide images. Optionally, the whole slide images are images of tumor tissue slices. In some implementations, the whole slide images are images of tissue slices stained with hematoxylin and eosin (H&E) stain. In some implementations, the whole slide images are images of tissue slices immunostained for different markers.

An example computer-implemented method for classifying one or more tiles of a digital histology image using a machine learning model is also described herein.

The method includes deploying a machine learning model; receiving a digital histology image; and extracting a plurality of tiles from the digital histology image. The method also includes inputting the plurality of tiles into the deployed machine learning model; and outputting, using the deployed machine learning model, a respective classification, and a respective uncertainty measure for each of the plurality of tiles.

Additionally, the deployed machine learning model is a deep learning model. Optionally, the deep learning model is a convolutional neural network (CNN). The CNN can include a plurality of fully connected layers and a plurality of dropout layers, where each of the plurality of dropout layers corresponds to a respective fully connected layer.

Alternatively, or additionally, the step of outputting, using the deployed machine learning model, the respective classification, and the respective uncertainty measure for each of the plurality of tiles includes inputting each of the plurality of tiles into the CNN; predicting, using the CNN, the respective classifications for each of the plurality of tiles; and obtaining the respective uncertainty measures for each of the plurality of tiles. Optionally, the step of obtaining the respective uncertainty measures for each of the plurality of tiles includes using a Monte Carlo simulation.

Alternatively, or additionally, the method further includes generating a classification map for the digital histology image using the respective classifications and the respective uncertainty measures for each of the plurality of tiles output by the deployed machine learning model.

Alternatively, or additionally, the digital histology image is a whole slide image. Optionally, the whole slide image is an image of a tumor tissue slice. In some implementations, the whole slide image is an image of a tissue slice stained with hematoxylin and eosin (H&E) stain. In some implementations, the whole slide image is an image of a tissue slice immunostained for different markers.

It should be understood that the above-described subject matter may also be implemented as a computer-controlled apparatus, a computer process, a computing system, or an article of manufacture, such as a computer-readable storage medium.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1A is an example whole slide image (WSI) with its WSI-level classification label. A plurality of tiles of the WSI are also shown in FIG. 1A. FIG. 1B illustrates a distribution of tiles of FIG. 1A based on the estimated prediction probabilities and uncertainty measures obtained according to an implementation described herein.

FIG. 1C illustrates the most diagnostically relevant tiles and the least diagnostically relevant tiles.

FIG. 2 is a block diagram illustrating a machine learning model training method including an Uncertainty-Aware Sampling Framework (UASF) for learning with weakly-labeled data according to an implementation described herein.

FIG. 3 is a block diagram illustrating a deployed machine learning model operating in inference mode according to an implementation described herein.

FIG. 4 is an example computing device.

FIG. 5 illustrates examples of identifying representative tiles for 3 WSIs across the three grades with the informative sampling algorithm described in an example below. The top row in FIG. 5 illustrates, for each WSI, determining the optimal threshold between the true predicted rate (TPR) and the false predicted rate (FPR) which provides the best trade-off between prediction probability and uncertainty. The bottom row in FIG. 5 illustrates, for each WSI, using the determined threshold to isolate and sample the tiles that are truly representative of the WSI grade.

FIG. 6 is a table (i.e. Table 1) illustrating the results of the Uncertainty-Aware Sampling Framework (UASF) described in the example below compared to RN18-HistoSSL on LMS dataset.

FIG. 7A illustrates the distribution of certainty (1.0-Uncertainty) versus prediction probability of all samples described in the example below. Grade 1 and grade 3 exhibit high variability in uncertainty, whereas grade 2 has the least amount, given the higher number of samples. FIG. 7B illustrates the distribution of tiles after isolating tiles deemed relevant based on informative index. All grades improved in mean certainty once informative tiles are identified (opaque), in comparison to tiles deemed irrelevant (light).

FIG. 8 illustrates an example Informative Sampling Algorithm described in the example below.

FIG. 9 illustrates the performance of the UASF described in the example below on CPTAC LMS dataset, which demonstrates the generalizability of UASF on “unseen” data. The WSI-level label was assigned based on the weighted majority of informative tiles for that respective WSI.

FIGS. 10A-10I illustrate the ground truth annotations for tumor (red) and non-tumor (blue and green) regions (left column), baseline classification maps generated by a baseline model trained on all training samples (e.g., LMS-All) described in the Example below (middle column), and informative classification maps generated by an Uncertainty Aware Convolutional Neural Network (UA-CNN) trained on relevant training samples (LMS-Informative) described in the Example below (right column). In particular, FIG. 10A illustrates Grade 1: Ground Truth, FIG. 10B illustrates Grade 1: Baseline Classification Map, FIG. 10C illustrates Grade 1: Informative Classification Map, FIG. 10D illustrates Grade 2: Ground Truth, FIG. 10E illustrates Grade 2: Baseline Classification Map, FIG. 10F illustrates Grade 2: Informative Classification Map, FIG. 10G illustrates Grade 3: Ground Truth, FIG. 10H illustrates Grade 3: Baseline Classification Map, FIG. 10I illustrates Grade 3: Informative Classification Map. Uncertainty map visualization confirmed the association of non-relevant tiles (gray tiles) to non-tumor tissue (green and blue ground truth annotation), demonstrating the potential of the UASF described herein to effectively sample relevant tiles, which enhance UA-CNN performance by reducing the negative impact of non-relevant tiles. FIGS. 10A-10I demonstrates that the performance of the UA-CNN trained on relevant training samples (LMS-Informative) is superior to that of the UA-CNN trained on all training samples (LMS-All).

### DETAILED DESCRIPTION

Unless defined otherwise, all technical and scientific terms used herein have the same meaning as commonly understood by one of ordinary skill in the art.

Methods and materials similar or equivalent to those described herein can be used in the practice or testing of the present disclosure. As used in the specification, and in the appended claims, the singular forms “a,” “an,” “the” include plural referents unless the context clearly dictates otherwise. The term “comprising,” and variations thereof as used herein is used synonymously with the term “including” and variations thereof and are open, non-limiting terms. The terms “optional” or “optionally” used herein mean that the subsequently described feature, event or circumstance may or may not occur, and that the description includes instances where said feature, event or circumstance occurs and instances where it does not. Ranges may be expressed herein as from “about” one particular value, and/or to “about” another particular value. When such a range is expressed, an aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. While implementations will be described for whole slide images, it will become evident to those skilled in the art that the implementations are not limited thereto but are applicable for other types of digital pathology images.

As used herein, the terms “about” or “approximately” when referring to a measurable value such as an amount, a percentage, and the like, is meant to encompass variations of ±20%, ±10%, ±5%, or ±1% from the measurable value.

The term “subject” is defined herein to include animals such as mammals, including, but not limited to, primates (e.g., humans), cows, sheep, goats, horses, dogs, cats, rabbits, rats, mice and the like. In some embodiments, the subject is a human.

As used herein, a solid tumor is an abnormal mass of hyperproliferative or neoplastic cells from a tissue other than blood, bone marrow, or the lymphatic system, which may be benign or cancerous. In general, the tumors described herein are cancerous. As used herein, the terms “hyperproliferative” and “neoplastic” refer to cells having the capacity for autonomous growth, i.e., an abnormal state or condition characterized by rapidly proliferating cell growth. Hyperproliferative and neoplastic disease states may be categorized as pathologic, i.e., characterizing or constituting a disease state, or may be categorized as non-pathologic, i.e., a deviation from normal but not associated with a disease state. The term is meant to include all types of solid cancerous growths, metastatic tissues or malignantly transformed cells, tissues, or organs, irrespective of histopathologic type or stage of invasiveness. “Pathologic hyperproliferative” cells occur in disease states characterized by malignant tumor growth. Examples of non-pathologic hyperproliferative cells include proliferation of cells associated with wound repair. Examples of solid tumors are sarcomas, carcinomas, and lymphomas. Leukemias (cancers of the blood) generally do not form solid tumors.

The term “carcinoma” is art recognized and refers to malignancies of epithelial or endocrine tissues including respiratory system carcinomas, gastrointestinal system carcinomas, genitourinary system carcinomas, testicular carcinomas, breast carcinomas, prostatic carcinomas, endocrine system carcinomas, and melanomas. In some implementations, the disease is lung carcinoma, rectal carcinoma, colon carcinoma, esophageal carcinoma, prostate carcinoma, head and neck carcinoma, or melanoma.

Exemplary carcinomas include those forming from tissue of the cervix, lung, prostate, breast, head, neck, colon, and ovary. The term also includes carcinosarcomas, e.g., which include malignant tumors composed of carcinomatous and sarcomatous tissues. An “adenocarcinoma” refers to a carcinoma derived from glandular tissue or in which the tumor cells form recognizable glandular structures.

The term “sarcoma” is art recognized and refers to malignant tumors of mesenchymal derivation.

The term “lymphoma” is art recognized and refers to cancer of the lymph nodes.

The term “artificial intelligence” is defined herein to include any technique that enables one or more computing devices or comping systems (i.e., a machine) to mimic human intelligence. Artificial intelligence (AI) includes, but is not limited to, knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders. The term “deep learning” is defined herein to be a subset of machine learning that that enables a machine to automatically discover representations needed for feature detection, prediction, classification, etc. using layers of processing. Deep learning techniques include, but are not limited to, artificial neural network or multilayer perceptron (MLP).

Systems and methods for training a machine learning model using weakly-labeled digital histology images are described herein. Systems and methods for classifying one or more tiles of a digital histology image using a machine learning model are also described herein. Optionally, the systems and methods further include generating classification maps (including uncertainty). Such uncertainty maps can be used to identify tiles within images that are more difficult to classify and grade. One advantage of the technique described herein is that it requires a minimal amount of curated and annotated data. Obtaining annotations from highly trained pathologists is expensive and often unattainable. The technique described herein provides alternatives that will usher in methods that rely less on training data.

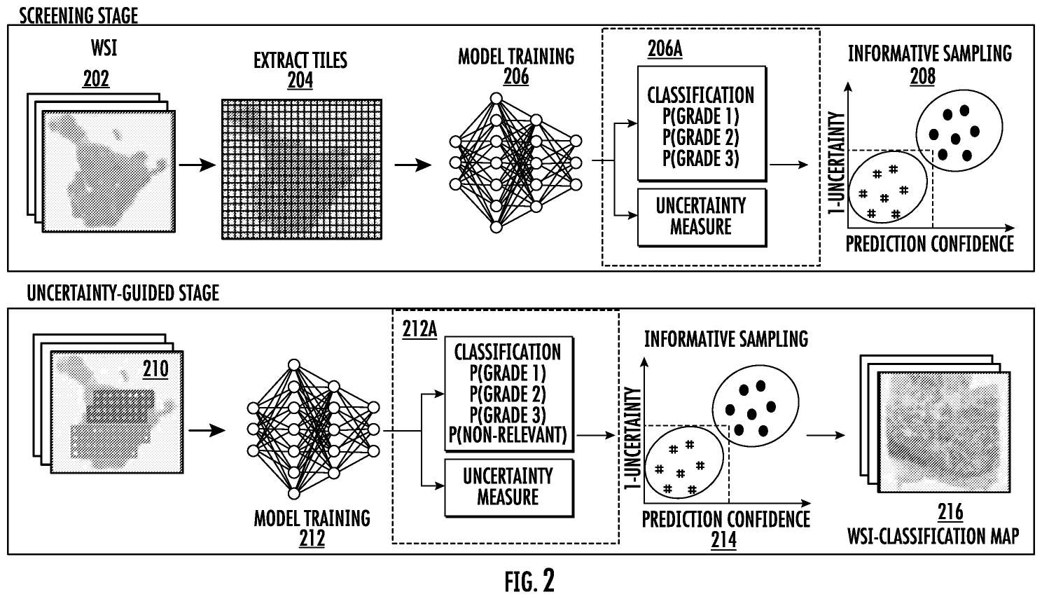

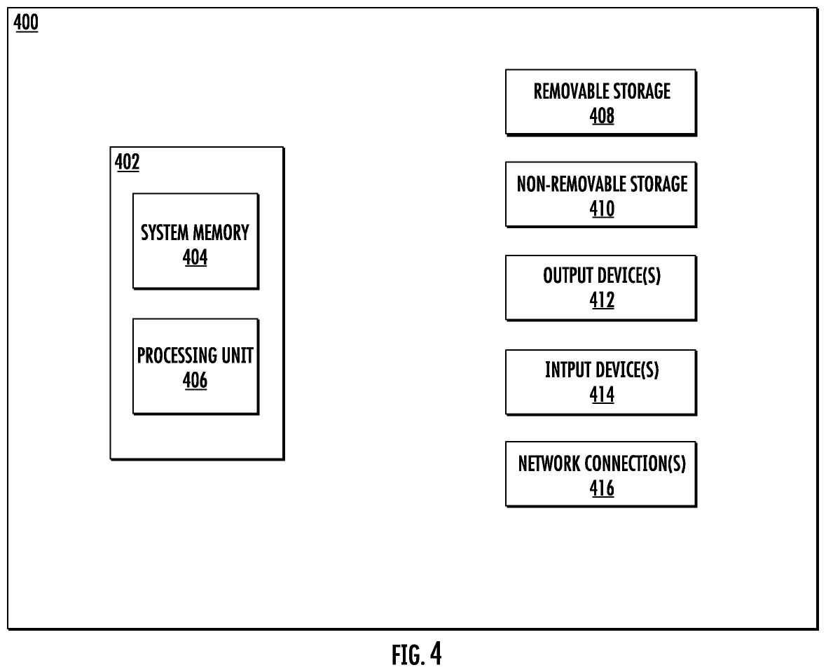

Referring now to FIG. 2, a method for training a machine learning model is shown. As described herein, this disclosure contemplates that the operations shown in FIG. 2 can be implemented by a computing device (e.g., computing device 400 of FIG. 4). In particular, FIG. 2 illustrates an Uncertainty-Aware Sampling Framework (UASF) for learning with weak labels. In the Screening Stage, a screening model is trained and then predicts tile-level labels with corresponding uncertainties. Then, an informative sampling is performed to identify the most relevant tiles in the training dataset. Thereafter, in the Uncertainty-guided Stage, a refined training dataset including the most relevant tiles is collected and an uncertainty-guided model is trained on the refined training dataset. The UASF described herein addresses one or more problems associated with weakly-labeled samples and/or label noise present in machine learning training datasets. As described in the Example below, conventional techniques including sampling-based, model-based, and Bayesian-based approaches have fallen short in addressing such problems. In contrast, the UASF provides a trained deep learning model that addresses such problems by reducing the impact of less relevant samples found in a weakly-labeled training dataset. The UASF achieves its objectives, in part, by training a screening model with a weakly labeled dataset (see e.g., step 206), sampling the dataset to identify the most relevant samples based on predictions and associated uncertainties provided by the trained screening model (see e.g., step 208), and training an uncertainty-guided model with the most relevant samples (see e.g., step 212). In other words, the UASF employs a two-stage framework in order to improve prediction performance by reducing the impact of non-relevant samples on model training and performance.

At step 202, a plurality of digital histology images are received, for example at a computing device. In the examples described herein, the digital histology images are whole slide images. For example, the whole slide images can be images of cancer tissue slices. Optionally, the cancer is a soft tissue sarcoma (STS). In some implementations, the whole slide images are images of tissue slices stained with hematoxylin and eosin (H&E) stain. It should be understood that H&E-stained images are provided only as an example. This disclosure contemplates that the whole slide images can be images of tissue stained with multiple colors including, but not limited to, images of tissue slices immunostained for different markers.

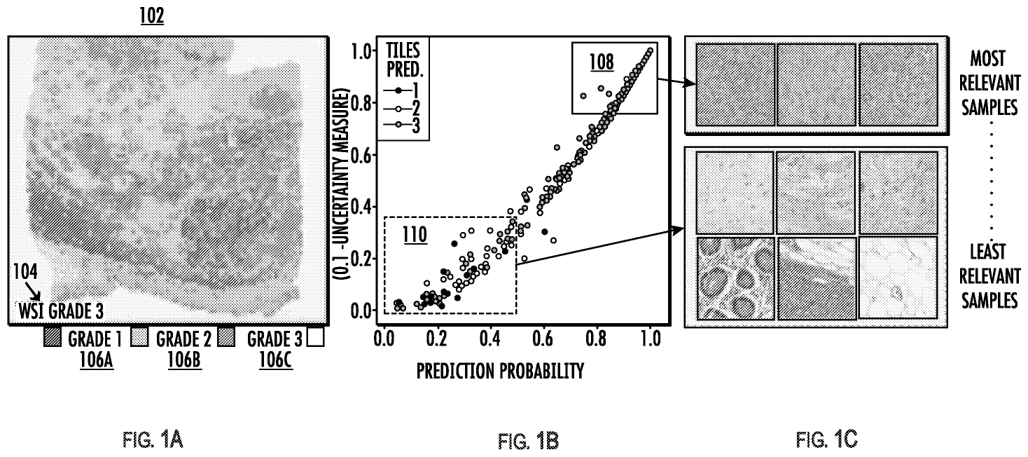

As described herein, each of the plurality of digital histology images is labeled with a respective image-level classification. For example, FIG. 1A illustrates an example whole slide image (WSI) 102 and its image-level classification 104 (i.e., WSI Grade 3). As shown in FIG. 1A, various tile-level classifications (e.g., WSI Grades 1 and 2) are different than the image-level classification (i.e., WSI Grade 3). In the examples described herein, the cancer is STS, and the classifications are pathologist-assigned tumor grades. An example tumor grade system is the French National Federation of Cancer Centers (FNCLCC) system, which uses diagnosis grades 1-3. It should be understood that FNCLCC system is provided only as an example. It should be understood that a digital histology image can include an image-level classification (e.g., WSI Grade 3 in FIG. 1A) and may also include one or more tile-level classifications (e.g., classifications 106A, 106B, and 106C in FIG. 1A).

At step 204, a plurality of tiles are extracted from each of the plurality of digital histology images. This disclosure contemplates extracting tiles using any techniques known in the art. In the examples described herein, digital pathology images are sectioned into 256×256 pixel tiles at 10× magnification. It should be understood that the tile size and magnification are provided only as examples. This disclosure contemplates extracting tiles having different tile size and/or magnification than described in the examples. Additionally, each of the plurality of tiles is labeled with a respective image-level classification associated with its respective digital pathology image. In other words, with reference to FIG. 1A, tiles of the WSI would be labeled with image-level classification 104 (i.e., WSI Grade 3), not a tile-level classification (e.g., one of classifications 106A, 106B, and 106C).

Additionally, a first dataset is created with the plurality of tiles and the respective image-level classifications. For example, a dataset including all of the plurality of tiles and the respective image-level classifications is partitioned into train, validation, and test datasets (i.e., train/validation/test splits). The first dataset is the train dataset, i.e., the first dataset contains the plurality of tiles and the respective image-level classifications from the train split. As described below, a second dataset contains the sampled tiles from the first dataset. The validation dataset is used to guide the training process (e.g., tell the model when to stop when no further learning is happening). The testing dataset is used to evaluate the performance of the models.

At step 206, a first machine learning model is trained using the first dataset. The first machine learning model can be a supervised machine learning model. In a supervised learning model, the model learns a function that maps an input (also known as feature or features) to an output (also known as target or targets) during training with a labeled data set (or dataset). In the examples described herein, the first dataset is referred to as weakly labeled because the each of the plurality of tiles is labeled with a respective image-level classification associated with its respective digital pathology image. In other words, the tiles are not labeled with a tile-level classifications. In some implementations, the first machine learning model is a deep learning model. Deep learning models include, but are not limited to, artificial neural networks (ANNs) including convolutional neural networks (CNNs). It should be understood that deep learning models are provided only as an example. This disclosure contemplates that the first machine learning model can be another type of supervised machine learning mode including, but not limited to, support vector machine (SVM).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers such as input layer, output layer, and optionally one or more hidden layers. An ANN having hidden layers can be referred to as deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanH, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation.

A convolutional neural network (CNN) is a type of deep neural network that has been applied, for example, to image analysis applications. Unlike a traditional neural networks, each layer in a CNN has a plurality of nodes arranged in three dimensions (width, height, depth). CNNs can include different types of layers, e.g., convolutional, pooling, and fully connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully connected layer includes neurons, where each neuron is connected to all of the neurons in the previous layer. The layers are stacked similar to traditional neural networks.

In the examples described herein, the first machine learning model is built from an open source CNN for image recognition (i.e., ResNet18) that has been pretrained according to a contrastive learning for visual representation framework (i.e., SimCLR framework) using a histopathology dataset (i.e., RN18-HistoSSL). Additionally, the backbone CNN's architecture is modified to include a plurality of fully connected layers, each followed by a dropout layer. In the examples described herein, the backbone CNN's architecture is modified to include three (3) fully connected layers, each followed by a dropout layer. A fully connected layer is provided to finetune the pretrained CNN on the first dataset. The last fully connected layer has a number of nodes for each of the classifications (e.g., FNCLCC grades 1-3). It should be understood that the number of fully connected layers may be more or less than three, for example depending on classification performance. It should be also understood that the number of the last fully connected layer may be more or less than three, for example depends on the number of classifications required. Additionally, as described herein, the dropout layers are used to prevent overfitting and also to enable Monte Carlo (MC) simulation.

In some implementations, the step of training the first machine learning model using the first dataset includes inputting the first dataset into the CNN; and processing, using the CNN, the first dataset to minimize or maximize an objective function for the CNN. It should be understood that this process maps an input (e.g., the tiles) to an output (e.g., the classification for the tiles). Thereafter, the first machine learning model is deployed for inference on the first dataset. For example, the step of training the first machine learning model using the first dataset further includes inputting the first dataset into the CNN; predicting, using the CNN, the respective classifications for each of the plurality of tiles; and obtaining the respective uncertainty measures for each of the plurality of tiles. As described in the examples herein, Monte Carlo (MC) simulation is performed at this stage. For example, a given tile can be input into the first machine learning model ‘T’ times (e.g., T=10), which results in ‘T’ different classification predictions. The final classification for the given tile can be computed as the average of the ‘T’ different classification predictions. Additionally, the uncertainty measure can be calculated as predictive entropy, which is a measure of the uncertainty of the first machine learning model's predictive density function for the variational inference for each tile. It should be understood that MC simulation is only provided as an example technique for obtaining uncertainty measures. This disclosure contemplates using other techniques to obtain the uncertainty measures including, but not limited to, deep ensembling or Bayesian neural networks (BNN). Accordingly, after training at step 206, the first machine learning model has output a respective classification and a respective uncertainty measure for each of the plurality of tiles. The classification and uncertainty measure are shown in dashed box 206A in FIG. 2.

At step 208, a second dataset is created by sampling the first dataset based on the respective classifications and the respective uncertainty measures output by the first machine learning model. The second dataset includes a subset of the plurality of tiles of the first dataset. For example, the subset of the plurality of tiles of the first dataset includes the most diagnostically relevant tiles among the plurality of tiles of the first dataset. FIG. 1B and FIG. 1C show a distribution of the tiles of FIG. 1A based on the predicted classifications and uncertainty measures obtained as described above in step 206. These figures illustrate the most diagnostically relevant tiles, which are labelled 108, and the least diagnostically relevant tiles, which are labelled 110. In FIG. 1B, the solid box contains the most diagnostically relevant tiles 108, which are associated with high predictive confidence and low uncertainty, and the dashed-line box contains the least diagnostically relevant tiles 110, which are associated with low predictive confidence and high uncertainty. In FIG. 1C, the image-level classifications of the most relevant samples are associated with the assigned WSI-level grade, while the least relevant samples consist of non-tumor regions, tissue artifacts, or image-level classifications different than the assigned WSI-level grade.

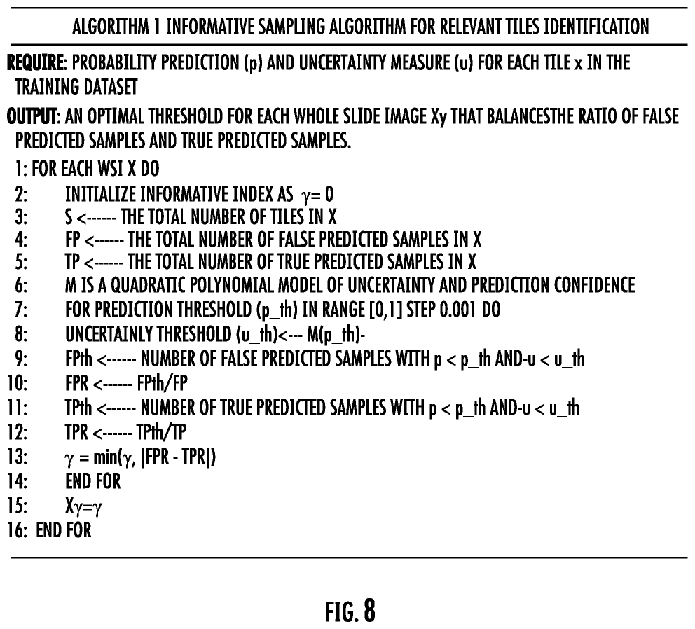

Optionally, the step of creating the second dataset by sampling the first dataset includes identifying one or more of the plurality of tiles of the first dataset having relatively high predictive probability and relatively low uncertainty (e.g., tiles 108 in FIG. 1B). In the examples described herein, the tiles having relatively high predictive probability and relatively low uncertainty are identified using a threshold value for predictive probability and uncertainty. It should be understood that using a threshold value is only provided as an example technique for identifying the most diagnostically relevant tiles. This disclosure contemplates using other techniques to identify the most diagnostically relevant tiles, but not limited to, sampling the top K ranked tiles where k can either be a fixed number of a percentage. Optionally, an informative sampling algorithm such as that shown in FIG. 8 can be used. It should be understood that the informative sampling algorithm of FIG. 8 is provided only as an example. Referring again to FIG. 2, the second dataset 210, which is created by sampling the first dataset at step 208, is shown in FIG. 2.

At step 212, a second machine learning model is trained using the second dataset 210. Additionally, the step of training the second machine learning model using the second dataset includes inputting the second dataset into the CNN; and processing, using the CNN, the second dataset to minimize or maximize an objective function for the CNN. In some implementations, the second machine learning model is a supervised machine learning model such as a deep learning model. In the examples described herein, the second machine learning model is built from an open-source CNN for image recognition (i.e., ResNet18) that has been pretrained according to a contrastive learning for visual representation framework (i.e., SimCLR framework) using a histopathology dataset (i.e., RN18-HistoSSL). Additionally, the backbone CNN's architecture is modified to include a plurality of fully connected layers, each followed by a dropout layer. In the examples described herein, the backbone CNN's architecture is modified to include three (3) fully connected layers, each followed by a dropout layer. A fully connected layer is provided to finetune the pretrained CNN on the first dataset. The last fully connected layer has a number of nodes for each of the classification classes (e.g., FNCLCC grades 1-3). It should be understood that the number of fully connected layers may be more or less than three, for example depending on the classification performance. It should be also understood that the number of nodes of the last fully connected layer may be more of less than three, for example depends on the number of classifications required. Additionally, as described herein, the dropout layers are used to prevent overfitting and also to enable Monte Carlo (MC) dropout testing.

After training at step 212, the second machine learning model is configured to classify one or more tiles of a new digital histology image when operating in inference mode. Such classification includes the classification and uncertainty measure are shown in dashed box 212A in FIG. 2. As described herein, the predictions may have relatively high predictive probability and relatively low uncertainty, i.e., upper right corner of chart 214, or may have relatively low predictive probability and relatively high uncertainty, i.e., lower left corner of chart 214. Optionally, as described below, a classification map 216 can be generated for the digital histology image. For example, predicted classifications can be represented by color (e.g., Grade 1=green, Grade 2=yellow, Grade 3=red) and uncertainty measures can be represented by shading (e.g., the lighter the shading, the higher the uncertainty).

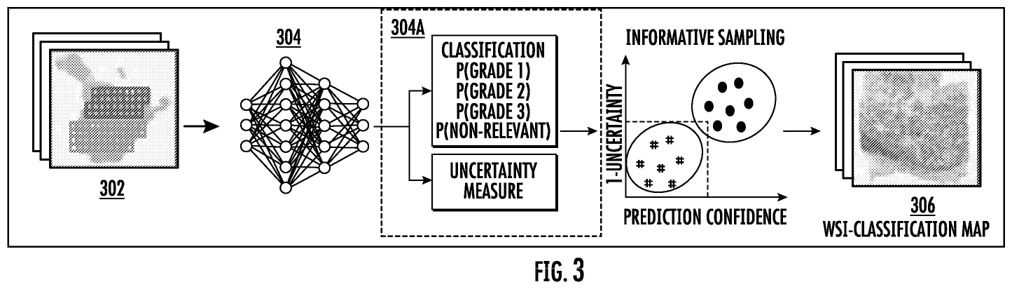

Referring now to FIG. 3, a method for classifying one or more tiles of a digital histology image using a machine learning model is shown. As described herein, this disclosure contemplates that the operations shown in FIG. 3 can be implemented by a computing device (e.g., computing device 400 of FIG. 4). At step 302, a digital histology image is received, for example at a computing device. In the examples described herein, the digital histology images are whole slide images. For example, the whole slide images can be images of cancer tissue slices. Optionally, the cancer is a soft tissue sarcoma (STS). In some implementations, the whole slide images are images of tissue slices stained with hematoxylin and eosin (H&E) stain. It should be understood that H&E-stained images are provided only as an example. This disclosure contemplates that the whole slide images can be images of tissue stained with multiple colors including, but not limited to, images of tissue slices immunostained for different markers. Additionally, a plurality of tiles are extracted from the digital histology image. This disclosure contemplates extracting tiles using any techniques known in the art. In the examples described herein, digital pathology images are sectioned into 256×256 pixel tiles at 10× magnification. It should be understood that the tile size and magnification are provided only as examples. This disclosure contemplates extracting tiles having different tile size and/or magnification than described in the examples.

At step 304, the plurality of tiles are input into the deployed machine learning model. The deployed machine learning model can be the machine learning model trained as described above with regard to FIG. 2. For example, the deployed machine learning model can be a CNN including a plurality of fully connected layers, each followed by a dropout layer. In response to input tiles, the deployed machine learning model outputs a respective classification and a respective uncertainty measure for each of the plurality of tiles. The classification and uncertainty measure are shown in dashed box 304A in FIG. 3.

In some implementations, the step of outputting, using the deployed machine learning model, a respective classification, and a respective uncertainty measure for each of the plurality of tiles includes inputting the second dataset into the CNN; predicting, using the CNN, the respective classifications for each of the plurality of tiles; and obtaining the respective uncertainty measures for each of the plurality of tiles. As described in the examples herein, Monte Carlo (MC) simulation is performed at this inference stage. For example, a given tile can be input into the second machine learning model ‘T’ times (e.g., T=10), which results in ‘T’ different classification predictions. The final classification for the given tile can be computed as the average of the ‘T’ different classification predictions. Additionally, the uncertainty measure can be calculated as predictive entropy, which is a measure of the uncertainty of the second machine learning model's predictive density function for the variational inference for each tile. As described above, it should be understood that MC simulation is only provided as an example technique for obtaining uncertainty measures. This disclosure contemplates using other techniques to obtain the uncertainty measures. Therefore, the second machine learning model is configured to output a respective classification and a respective uncertainty measure for each of the plurality of tiles.

At step 306, a classification map for the digital histology image is generated using the respective classifications and the respective uncertainty measures for each of the plurality of tiles output by the deployed machine learning model. For example, predicted classifications can be represented by color (e.g., Grade 1=green, Grade 2=yellow, Grade 3=red) and uncertainty measures can be represented by shading (e.g., the lighter the shading, the higher the uncertainty). Example tile-level classifications as predicted by a deployed machine learning model is also shown in FIG. 1A, where Grades 1-3 are shown as classifications 106A, 106B, and 106C.

It should be appreciated that the logical operations described herein with respect to the various figures may be implemented (1) as a sequence of computer implemented acts or program modules (i.e., software) running on a computing device (e.g., the computing device described in FIG. 4), (2) as interconnected machine logic circuits or circuit modules (i.e., hardware) within the computing device and/or (3) a combination of software and hardware of the computing device. Thus, the logical operations discussed herein are not limited to any specific combination of hardware and software. The implementation is a matter of choice dependent on the performance and other requirements of the computing device. Accordingly, the logical operations described herein are referred to variously as operations, structural devices, acts, or modules. These operations, structural devices, acts and modules may be implemented in software, in firmware, in special purpose digital logic, and any combination thereof. It should also be appreciated that more or fewer operations may be performed than shown in the figures and described herein. These operations may also be performed in a different order than those described herein.

Referring to FIG. 4, an example computing device 400 upon which the methods described herein may be implemented is illustrated. It should be understood that the example computing device 400 is only one example of a suitable computing environment upon which the methods described herein may be implemented. Optionally, the computing device 400 can be a well-known computing system including, but not limited to, personal computers, servers, handheld or laptop devices, multiprocessor systems, microprocessor-based systems, network personal computers (PCs), minicomputers, mainframe computers, embedded systems, and/or distributed computing environments including a plurality of any of the above systems or devices. Distributed computing environments enable remote computing devices, which are connected to a communication network or other data transmission medium, to perform various tasks. In the distributed computing environment, the program modules, applications, and other data may be stored on local and/or remote computer storage media.

In its most basic configuration, computing device 400 typically includes at least one processing unit 406 and system memory 404. Depending on the exact configuration and type of computing device, system memory 404 may be volatile (such as random access memory (RAM)), non-volatile (such as read-only memory (ROM), flash memory, etc.), or some combination of the two. This most basic configuration is illustrated in FIG. 4 by dashed line 402. The processing unit 406 may be a standard programmable processor that performs arithmetic and logic operations necessary for operation of the computing device 400. The computing device 400 may also include a bus or other communication mechanism for communicating information among various components of the computing device 400.

Computing device 400 may have additional features/functionality. For example, computing device 400 may include additional storage such as removable storage 408 and non-removable storage 410 including, but not limited to, magnetic or optical disks or tapes. Computing device 400 may also contain network connection(s) 416 that allow the device to communicate with other devices. Computing device 400 may also have input device(s) 414 such as a keyboard, mouse, touch screen, etc. Output device(s) 412 such as a display, speakers, printer, etc. may also be included. The additional devices may be connected to the bus in order to facilitate communication of data among the components of the computing device 400. All these devices are well known in the art and need not be discussed at length here.

The processing unit 406 may be configured to execute program code encoded in tangible, computer-readable media. Tangible, computer-readable media refers to any media that is capable of providing data that causes the computing device 400 (i.e., a machine) to operate in a particular fashion. Various computer-readable media may be utilized to provide instructions to the processing unit 406 for execution. Example tangible, computer-readable media may include, but is not limited to, volatile media, non-volatile media, removable media, and non-removable media implemented in any method or technology for storage of information such as computer readable instructions, data structures, program modules or other data. System memory 404, removable storage 408, and non-removable storage 410 are all examples of tangible, computer storage media. Example tangible, computer-readable recording media include, but are not limited to, an integrated circuit (e.g., field-programmable gate array or application-specific IC), a hard disk, an optical disk, a magneto-optical disk, a floppy disk, a magnetic tape, a holographic storage medium, a solid-state device, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices.

In an example implementation, the processing unit 406 may execute program code stored in the system memory 404. For example, the bus may carry data to the system memory 404, from which the processing unit 406 receives and executes instructions. The data received by the system memory 404 may optionally be stored on the removable storage 408 or the non-removable storage 410 before or after execution by the processing unit 406.

It should be understood that the various techniques described herein may be implemented in connection with hardware or software or, where appropriate, with a combination thereof. Thus, the methods and apparatuses of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computing device, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high-level procedural or object-oriented programming language to communicate with a computer system. However, the program(s) can be implemented in assembly or machine language, if desired. In any case, the language may be a compiled or interpreted language and it may be combined with hardware implementations.

### Examples

The following examples are put forth so as to provide those of ordinary skill in the art with a complete disclosure and description of how the compounds, compositions, articles, devices and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

The Example below presents an importance-based sampling framework on weak labels, which is referred to herein as the Uncertainty-Aware Sampling Framework (UASF). This framework combines recent advances in Bayesian deep learning and weakly supervised techniques to systematically identify the most diagnostically relevant tiles of a WSI by estimating prediction uncertainty and retaining tiles with higher confidence.

Uncertainty measures estimated by Bayesian neural networks can not only identify samples that are hard to classify but can also detect samples that deviate from the data used for training the model. Consequently, UASF enables deep learning models to be effective when training on weak labels by reducing the impact of non-relevant tiles in the training set. The ensuing uncertainty maps also guide identifying tiles that are harder to classify and grade. Extensive experiments demonstrate the effectiveness of the sampling framework, UASF, on the grading of leiomyosarcoma (LMS) WSIs achieving higher accuracy by sampling a smaller, more relevant subset tiles compared to baseline models.

### Conventional Approaches

Recent studies have investigated various approaches to reduce the negative impact of label noise of prediction tasks [18]. Sampling-based methods focus on identifying and either relabeling or discarding samples with corrupted labels. A recent study by Naik et al. [20], followed a random sampling approach by selecting random tiles from each WSI to predict estrogen receptor status. Bilal et al. [2] presented a method that requires a tumor detection model to identify tumor tiles relevant as samples from a given WSI. Another approach proposed by Yao et al. [26] requires tiles to be sampled from generated clusters obtained from the application of the K-means algorithm for tissue morphology. The performance of this class of methods relies on sufficiently large datasets for the sampling technique to capture informative (relevant) tiles associated with the weak WSI-level label.

Model-based methods focus on model selection, loss functions, or training processes that are more robust to label noise. Ghosh et al. [14] showed that the mean absolute value of error (MAE) is tolerant of label noise in segmentation tasks. For classification tasks, the symmetric cross-entropy (SCE) loss [25] was proposed by combining reverse cross-entropy (RCE) together with the cross-entropy measure to overcome the risk of training error associated with weak labels: LSCE =LCE +LERCE.

Despite the success of CNN architectures, it is infeasible to quantify their uncertainty given the deterministic nature associated with their parameters. To address this limitation, Bayesian machine learning approaches have been employed to estimate the uncertainty associated with each prediction [19]. Gal and Ghahramani [12] showed that combining dropout regularization proposed by Srivastava et al. [22] with Bayesian modeling can derive uncertainty estimates in deep learning classification tasks. Thiagarajan et al. [23] proposed a Bayesian CNN (BCNN) to facilitate interpretation, visualization, and performance evaluation based on a predetermined uncertainty threshold for breast cancer images. However, BCNNs are computationally expensive compared to CNNs. Furthermore, a fixed threshold may not work for all WSIs in a collection. Given the tissue heterogeneity for WSIs, there is a need to optimize the uncertainty threshold for each WSI.

The UASF described below addresses shortcomings of the sampling-based, model-based, and Bayesian-based techniques for dealing with noisy labels.

### Methods

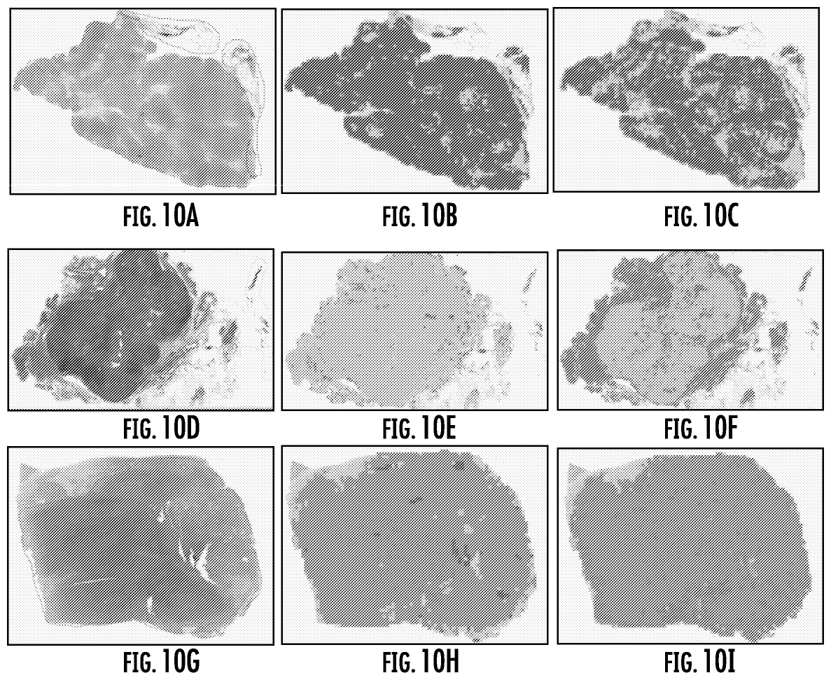

Uncertainty-Aware Sampling Framework (UASF): Inspired by the workflow of pathologists, the two-stage framework is visualized in FIG. 2. In the first screening stage, training tiles (LMS-All) are provided to the Uncertainty Aware Convolutional Neural Network (UA-CNN) classifier. Upon successful training, an informative sampling algorithm (see FIG. 8) is performed to identify the most relevant tiles predictive of their WSI-level label. Then, in the uncertainty-guided stage, another UA-CNN model is trained on the relevant subset of tiles (LMS-Informative) determined from the screening stage. For inference, a given WSI is split into a set of smaller-sized tiles. Each tile is classified by UA-CNN model from the uncertainty-guided stage and assigned a color and intensity based on predicted label and uncertainty measure. Colored tiles are reassembled into a WSI to form an uncertainty classification map, so pathologists can make informed decisions to accept the automated classification or to manually inspect the results. Example uncertainty classification maps are shown, for example, in FIGS. 10B, 10C, 10E, 10F, 10H, and 10I.

Uncertainty-Aware Convolutional Neural Network (UA-CNN): The uncertainty-aware model was built using a backbone composed of a previously published implementation of Resnet18 (RN18) [16] that is pre-trained with SimCLR [5], a framework for self-supervising contrastive learning of visual representations, on a total of 57 unlabeled histopathology datasets (RN18-HistoSSL) [8]. To create UA-CNN, the network architecture of RN18-HistoSSL was further modified by adding three fully connected layers, each followed by a dropout layer. The dropout layers are used to prevent overfitting [22], which in turn, allows us to apply Monte Carlo (MC) dropout during testing to obtain uncertainty estimation. In the baseline models, indicated by “RN18-HistoSSL+L” in Table 1, the uncertainty estimation is removed by deactivating these dropout layers at inference.

Monte Carlo (MC) Dropout: MC dropout [12] (dropout rate=0.5) was adopted during inferencing in order to estimate uncertainties associated with neural network outputs. Variational inference was performed for a given tile, leading to a collection of T different predictions. In the models, T=10. The final prediction for a sample is computed as the average of the variational predictions, providing a robust classification.

Predictive Entropy: Predictive entropy is a measure of the uncertainty of the model's predictive density function for the variational inference of each sample. It measures both epistemic uncertainty, i.e., uncertainty measure based on the underlying model, and aleatoric uncertainty, i.e., uncertainty based on the underlying noise in the data [11]. It is defined as: H[P(y*|x, D)]=−Σ^{C}_{c=1}P(y*=c|x, D) log P(y*=c|x, D) where C is the total number of classes and P (y*=c|x, D) is the output softmax probability for input x belonging to class c. A higher entropy indicates that the model is less confident about its prediction and vice versa, Loss Function: Robust loss functions are essential for training an accurate CNN in the presence of ambiguity and noisy labels. The reviewed loss functions of the conventional approaches described above assume that labels are mutually exclusive and do not account for the ordinal nature of the grading labels in the problem. If a model predicted a sample grade 3 instead of grade 1, it should penalize more than if predicted grade 2. The Ordinal Regression (OR) loss function was introduced to adapt a traditional neural network to learn ordinal labels [6]. Each class output node O_{c} class nodes uses a standard sigmoid function

$$σ ( z ) = \frac{1}{1 + {e}^{- z}} .$$

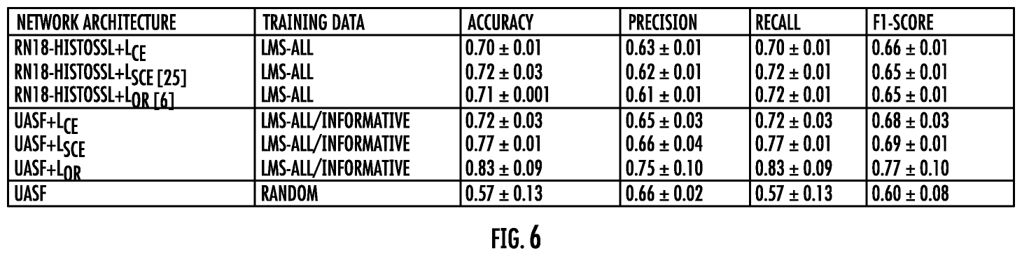

Without the input from other class nodes. Thus, a sample x is predicted as class c if the output prediction is O=(1, . . . , 1, 0, . . . , 0), in which the first c elements is 1 and the remaining are assigned 0. To evaluate the effectiveness of state-of-the-art loss functions for reducing the negative impact of label noise, UA-CNN performance trained on the cross-entropy loss L_{CE} (baseline), symmetric cross-entropy loss L_{SCE}, and ordinal regression loss L_{OR} were compared. Results are shown in Table 1 (FIG. 6).

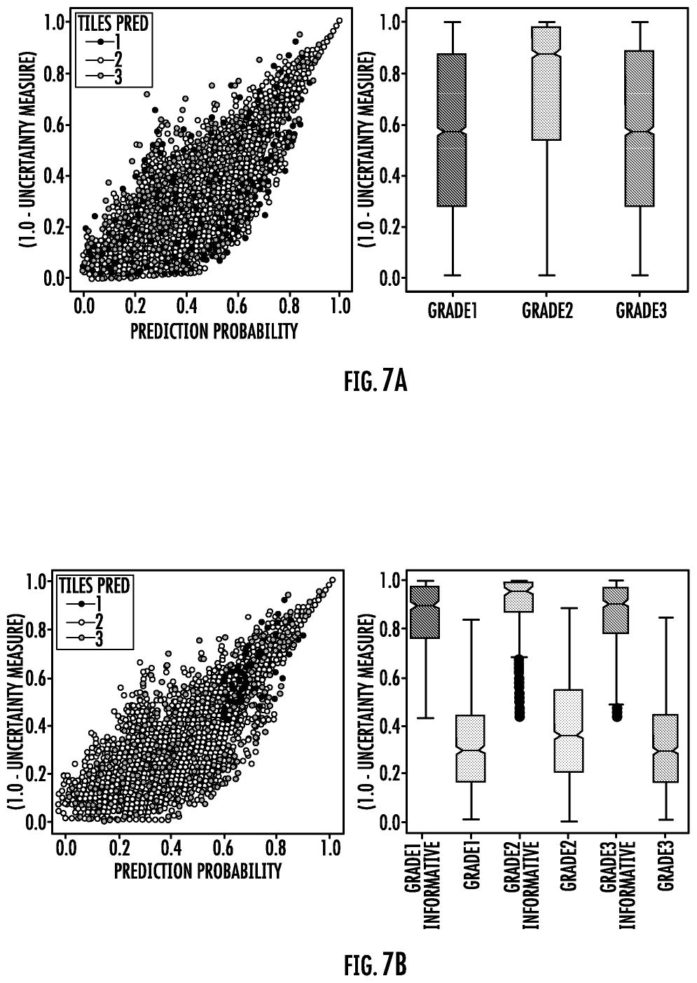

Informative Sampling Algorithm: FIG. 7A shows a plot of the uncertainty and prediction probability for the entirety of the training data. It was first assumed that the most relevant tiles have the same accorded label of the given WSI with high confidence, implying high prediction probability (found from the overall model) and low uncertainty (found from the variational Monte-Carlo inference). Uncertainty was modeled using a quadratic function of prediction confidence for each WSI. The next goal is to identify a threshold that allows the selection of the most relevant tiles with respect to the tile distribution of a WSI.

A straightforward approach is to set a hard threshold. Yet, given tissue heterogeneity, the variability of tile distribution makes it difficult to set fixed thresholds for all WSIs. Thus, it will be useful to select a threshold of the prediction probability and uncertainty measure that maximizes the number of true predicted tiles (tile labels matching WSI-level label) and minimizes the number of false predicted tiles (tile labels not matching WSI-level label). Two factors dictate the level of the optimal threshold for each WSI: (i) the overall uncertainty measure of the WSI samples and (ii) the variability of tile predictions. It is noted that this method is not practical to apply on the entire training data set because minority classes tend to show higher measures of uncertainty compared to majority classes, which leads to biased sampling.

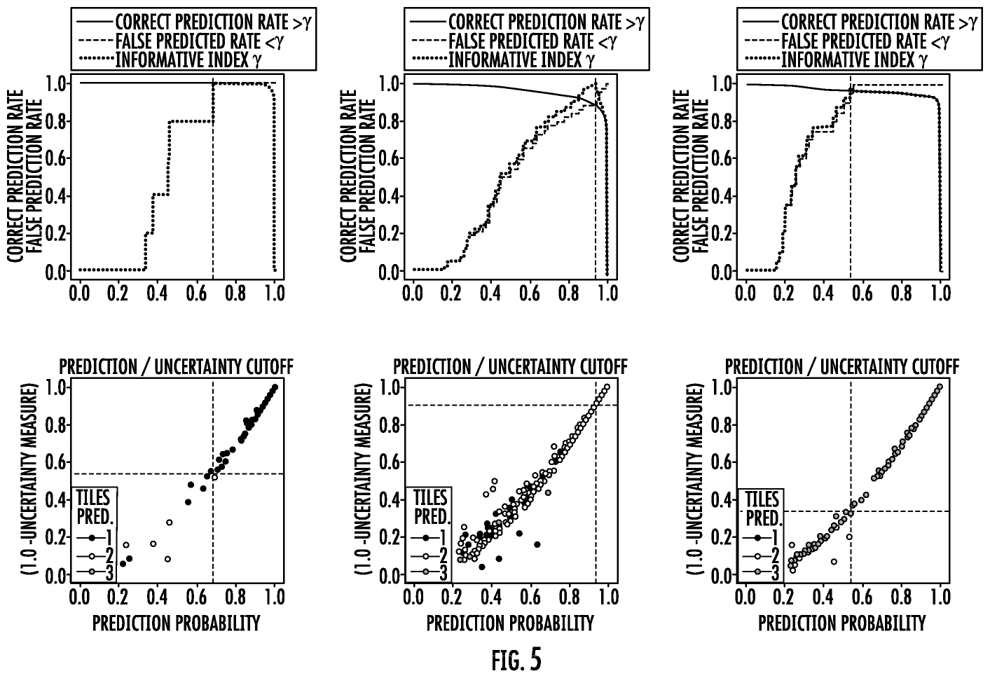

To find the best trade-off between representative and non-representative tiles for each WSI, the difference between the true predicted rate (TPR) and false predicted rate (FPR) was computed at each threshold γ. The optimal threshold was determined by identifying the minimum of y as shown in FIG. 5. (1-min) was plotted for easily interpretable visualizations. This informative sampling is examined qualitatively in FIG. 5 and quantitatively in Table 1 (FIG. 6), which demonstrates the effectiveness of the informative policy as an indicator for relevant samples. A detailed pseudocode algorithm is shown in FIG. 8.

### Experiments

Dataset: The experiments employ the data collections from the Cancer Genome Atlas (TCGA). 85 H&E stained WSIs of subjects diagnosed with leiomyosarcoma (LMS) were especially considered. This collection also consists of clinical data obtained from a comprehensive study of adult subjects [1].

Each WSI is assigned a grade label based on the FNCLCC grading system [15]. Grade 1 counts 12 WSIs, grade 2 counts 58 WSIs, while grade 3 counts 15 WSIs. It is important to note that although the LMS cohort represents a single subtype, there is a wide range of variability in morphological structures due to different anatomic origins of tissue. To examine the generalizability of the UASF, 121 WSIs with tumor and non-tumor labels from the National Cancer Institute's Clinical Proteomic Tumor Analysis Consortium (CPTAC) database were utilized to predict whether a WSI has tumor or non-tumor regions.

Experimental Set Up: Three-fold cross-validation experiments were performed. For each experiment, the dataset is randomly partitioned into a training set (80% of cases), validation set (10% of cases), and test set (10% of cases). For each fold, the model's performance on the validation set is monitored during training and used for hyper-parametric regularization while the test set is held out until the end of training to evaluate the model.

Implementation Details: All slides are preprocessed for tissue segmentation using the HistomicsTK API [9]. WSIs are sectioned into 256×256px tiles at 10× magnification level, giving a total number of 1.5M tiles. Accuracy, precision, recall, and F1-score metrics were adopted as the evaluation criteria for predicting grade. The performance of a baseline model, which is built on a Resnet18 backbone pre-trained on histological images (i.e., HistoSSL) and then trained on all training samples (LMS-All), is compared to the UA-CNN model, which is the baseline with the dropout layers activated for variational inference and trained on relevant training samples (LMS-Informative). The validation and testing sets were kept identical in those experiments. The training takes 100 epochs with an early stop if the minimum validation loss did not improve for 15 epochs.

The inference time for a WSI is highly affected by the variational inference parameter T. For T=10, it takes 4 minutes to generate an uncertainty map for a single WSI on an NVIDIA Tesla P100 (Pascal) GPU. The Ohio Supercomputer Center [4] was used to run our experiments. The two-stage UASF framework was implemented in PyTorch, which is an open source machine learning framework developed by Linux Foundation of San Francisco, CA and Meta AI of New York City, NY.

### Results

The stated objectives of this work were two-fold: (i) effective identification of disease-representative tiles using informative sampling algorithm and (ii) enhanced prediction performance using an uncertainty-aware model trained on representative tiles.

Effectiveness of Informative Sampling Analysis: FIG. 7B shows the uncertainty vs. prediction probability of informative sampled tiles. When representative tiles were isolated from non-representative tiles, all three grades improved in mean certainty, (1.0—uncertainty). To verify that UASF was able to identify diagnostically representative tiles, a subset of WSIs were annotated by pathologists into tumor and non-tumor regions. The UA-CNN assigned an uncertainty measure to tiles extracted from tumor and non-tumor regions. A paired two-sample t-test was performed to compare the mean uncertainty measure of tumor tiles and non-tumor tiles. There was a significant difference in the uncertainty measure between tumor and non-tumor tiles; t(47815) =−36.07, α=0.05, p-value<0.001, which further confirms the robustness of the informative policy (a denotes the level of significance).

Effectiveness of UASF: The performance comparison between models trained on the LMS-All (baseline model) and LMS-Informative datasets (informative model), ensured that the informative sampling technique was producing superior results by identifying disease-representative tiles. Table 1 demonstrates the effectiveness of UASF on the leiomyosarcoma (LMS) histological subtype grading task, achieving 83% accuracy as a result of filtering out 30% of samples as non-informative, which is a 12% relative improvement compared to the baseline scenario trained on all samples. When comparing performance across the different loss functions, UA-CNN models trained on LMS-Informative significantly outperformed their respective baseline model trained on LMS-All. Notably, OR loss outperformed SCE loss for LMS-Informative experiments. OR is not as robust as SEC at first, but when trained on clean labels, it can learn the monotonic property of the ordinal labels [13]. Randomly selected samples from each WSI were used as a control group to demonstrate the importance and effectiveness of determining relevant samples to a WSI. All the above-mentioned experiments were evaluated on the same validation and testing data for a fair comparison.

FIGS. 10A-10I illustrate the ground truth annotations for tumor (red) and non-tumor (blue and green) regions (left column), baseline classification maps generated by a baseline model trained on all training samples (e.g., LMS-All) described in the Example below (middle column), and informative classification maps generated by an Uncertainty Aware Convolutional Neural Network (UA-CNN) trained on relevant training samples (LMS-Informative) described in the Example below (right column). Uncertainty map visualization confirmed the association of non-relevant tiles (gray tiles) to non-tumor tissue (green and blue ground truth annotation), demonstrating the potential of the UASF described herein to effectively sample relevant tiles, which enhance UA-CNN performance by reducing the negative impact of non-relevant tiles. FIGS. 10A-10I demonstrate that the performance of the UA-CNN trained on relevant training samples (LMS-Informative) is superior to that of the UA-CNN trained on all training samples (LMS-All).

Generalization of UASF: The UA-CNN trained on LMS-Informative was applied on the CPTAC dataset to verify the generalizability of UASF to predict the tumor and non-tumor regions of a WSI. The three grade classes were adapted to represent tumor tiles and a non-relevant class to represent non-tumor tiles. The WSI-level label was assigned to tiles based on the weighted majority of informative tiles in a given WSI. The model that was not explicitly trained on tumor detection could classify WSIs into tumor vs. normal WSI with 87% accuracy (F1-score: 0.91 (normal), 0.76 (tumor)). The ability of UA-CNN to generalize offers the potential of handling “unseen” histopathology images, thereby facilitating its future use especially since fewer expert annotations are required.

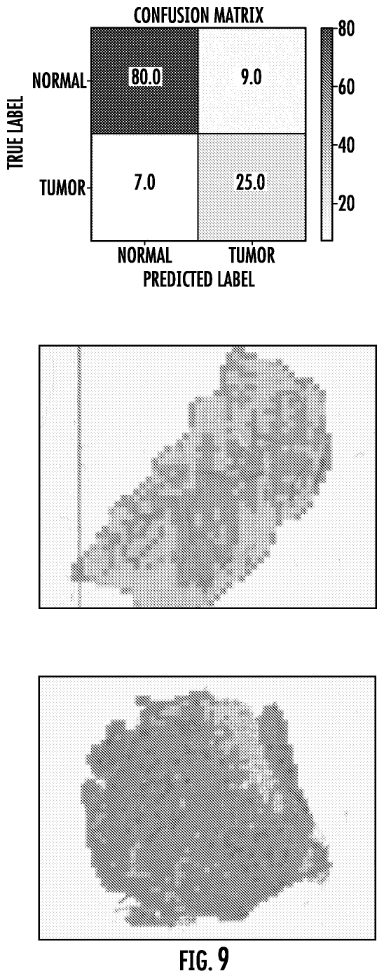

FIG. 9 illustrates the performance of the UASF described in the example below on CPTAC LMS dataset, which demonstrates the generalizability of UASF on “unseen” data. The WSI-level label was assigned based on the weighted majority of informative tiles for that respective WSI.

### Conclusion

The Example describes a two-stage Uncertainty-Aware Sampling Framework, UASF, to improve prediction performance of convolution neural networks for histopathology images by sampling the most relevant tiles and reducing the ad-verse impact of non-relevant tiles of a whole slide image. The framework utilized the model's uncertainty to determine a threshold at which disease-relevant regions would be prioritized. As a result, better performance was achieved by only sampling the most relevant training tiles, whereas the performance of the baseline models are degraded by irrelevant tiles and artifacts.

### References

[1] Abeshouse, A.A., Adebamowo, C., Adebamowo, S.N., et al.:

Comprehensive and integrated genomic characterization of adult soft tissue sarcomas. Cell pp. 950-965.e28 (2017).
[2] Bilal, M., e Ahmed Raza, S., Azam, A., Graham, S., Ilyas, M., Cree, I.A., Snead, D.R. J., Minhas, F.A., Rajpoot, N.M.: Development and validation of a weakly supervised deep learning framework to predict the status of molecular pathways and key mutations in colorectal cancer from routine histology images: a retrospective study. The Lancet. Digital health (2021).
[3] Campanella, G., Hanna, M.G., Geneslaw, L., Miraflor, A.P., Silva, V.W. K., Busam, K.J., Brogi, E., Reuter, V.E., Klimstra, D.S., Fuchs, T.J.: Clinical-grade computational pathology using weakly supervised deep learning on whole slide images. Nature Medicine pp. 1-9 (2019)
[4] Center, O.S.: Ohio supercomputer center (1987).
[5] Chen, T., Kornblith, S., Norouzi, M., Hinton, G.E.: A simple framework for contrastive learning of visual representations. ArXiv abs/2002.05709 (2020).
[6] Cheng, J., Wang, Z., Pollastri, G.: A neural network approach to ordinal regression. 2008 IEEE International Joint Conference on Neural Networks (IEEE World Congress on Computational Intelligence) pp. 1279-1284 (2008).
[7] Choi, J., Ro, J.: The 2020 who classification of tumors of soft tissue: Selected changes and new entities. Advances In Anatomic Pathology 28, 44-58 (2020).
[8] Ciga, O., Martel, A.L., Xu, T.: Self supervised contrastive learning for digital histopathology. ArXiv abs/2011.13971 (2020).
[9] Cooper, L.: Histomicstk: Developing an open-sourced platform for integrated histopathology analysis (2017).
[10] Coudray, N., Ocampo, P.S., Sakellaropoulos, T., Narula, N., Snuderl, M., Fenyo, D., Moreira, A.L., Razavian, N., Tsirigos, A.: Classification and mutation prediction from non-small cell lung cancer histopathology images using deep learning. Nature Medicine 24, 1559-1567 (2018).
[11] Gal, Y.: Uncertainty in deep learning (2016).
[12] Gal, Y., Ghahramani, Z.: Dropout as a bayesian approximation: Representing model uncertainty in deep learning. ArXiv abs/1506.02142 (2016).
[13] Garg, B., Manwani, N.: Robust deep ordinal regression under label noise. CoRR abs/1912.03488 (2019).
[14] Ghosh, A., Kumar, H., Sastry, P.S.: Robust loss functions under label noise for deep neural networks. In: AAAI (2017).
[15] Hasegawa, T., Yamamoto, S., Nojima, T., Hirose, T., Nikaido, T., Yamashiro, K., Matsuno, Y.: Validity and reproducibility of histologic diagnosis and grading for adult soft-tissue sarcomas. Human pathology pp. 111-5 (2002).
[16] He, K., Zhang, X., Ren, S., Sun, J.: Deep residual learning for image recognition. 2016 IEEE Conference on Computer Vision and Pattern Recognition (CVPR) pp. 770-778 (2016).
[17] lanni, J.D., Soans, R., Sankarapandian, S., Chamarthi, R.V., Ayyagari, D., Olsen, T.G., Bonham, M.J., Stavish, C.C., Motaparthi, K., Cockerell, C.J., Feeser, T.A., Lee, J.B.: Tailored for real-world: A whole slide image classification system vali-dated on uncurated multi-site data emulating the prospective pathology workload. Scientific Reports 10 (2020).
[18] Karimi, D., Dou, H., Warfield, S., Gholipour, A.: Deep learning with noisy labels: exploring techniques and remedies in medical image analysis. Medical image analysis 65, 101759 (2020).
[19] Kuleshov, V., Fenner, N., Ermon, S.: Accurate uncertainties for deep learning using calibrated regression. ArXiv abs/1807.00263 (2018).
[20] Naik, N., Madani, A., Esteva, A., Keskar, N.S., Press, M.F., Ruderman, D.L., Agus, D.B., Socher, R.: Deep learning-enabled breast cancer hormonal receptor status determination from base-level h&e stains. Nature Communications 11 (2020).
[21] Schmauch, B., Romagnoni, A., Pronier, E., Saillard, C., Maille, P., Calderaro, J., Kamoun, A., Sefta, M., Toldo, S., Zaslavskiy, M., Clozel, T., Moarii, M., Courtiol, P., Wainrib, G.: A deep learning model to predict rna-seq expression of tumours from whole slide images. Nature Communications 11 (2020).
[22] Srivastava, N., Hinton, G.E., Krizhevsky, A., Sutskever, I., Salakhutdinov, R.: Dropout: a simple way to prevent neural networks from overfitting. J. Mach. Learn. Res. 15, 1929-1958 (2014).
[23] Thiagarajan, P., Khairnar, P., Ghosh, S.: Explanation and use of uncertainty quantified by bayesian neural network classifiers for breast histopathology images. IEEE Transactions on Medical Imaging 41, 815-825 (2022).
[24] Trojani, M., Contesso, G., Coindre, J., Rouesse, J., Bui, N., de Mascarel, A., Goussot, J., David, M., Bonichon, F., Lagarde, C.: Soft-tissue sarcomas of adults; study of pathological prognostic variables and definition of a histopathological grading system. International Journal of Cancer 33 (1984).
[25] Wang, Y., Ma, X., Chen, Z., Luo, Y., Yi, J., Bailey, J.: Symmetric cross entropy for robust learning with noisy labels. 2019 IEEE/CVF International Conference on Computer Vision (ICCV) pp. 322-330 (2019).
[26] Yao, J., Zhu, X., Jonnagaddala, J., Hawkins, N., Huang, J.: Whole slide images based cancer survival prediction using attention guided deep multiple instance learning networks. Medical image analysis 65, 101789 (2020).

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-implemented method for training a machine learning model comprising:
receiving a plurality of digital histology images, wherein each of the plurality of digital histology images is labeled with a respective image-level classification;
extracting a plurality of tiles from each of the plurality of digital histology images, wherein each of the plurality of tiles is labeled with a respective image-level classification associated with its respective digital pathology image;
creating a first dataset comprising the plurality of tiles and the respective image-level classifications;
training a first machine learning model using the first dataset, wherein the trained first machine learning model is configured to output a respective classification and a respective uncertainty measure for each of the plurality of tiles;
creating a second dataset by sampling the first dataset based on the respective classifications and the respective uncertainty measures output by the trained first machine learning model; and
training a second machine learning model using the second dataset, wherein the trained second machine learning model is configured for classify one or more tiles of a digital histology image.

2. The computer-implemented method of claim 1, wherein the second dataset comprises a subset of the plurality of tiles of the first dataset.

3. The computer-implemented method of claim 2, wherein the subset of the plurality of tiles of the first dataset comprises the most diagnostically relevant tiles among the plurality of tiles of the first dataset.

4. The computer-implemented method of claim 1, wherein the step of creating the second dataset by sampling the first dataset comprises identifying one or more of the plurality of tiles of the first dataset having relatively high predictive probability and relatively low uncertainty.

5. The computer-implemented method of claim 4, wherein the one or more of the plurality of tiles of the first dataset having relatively high predictive probability and relatively low uncertainty are identified using a threshold value for predictive probability and uncertainty.

6. The computer-implemented method of claim 1, wherein the first machine learning model is a deep learning model.

7. The computer-implemented method of claim 6, wherein the deep learning model is a convolutional neural network (CNN), wherein the CNN comprises a plurality of fully connected layers and a plurality of dropout layers, wherein each of the plurality of dropout layers corresponds to a respective fully connected layer.

8. The computer-implemented method of claim 7, wherein the step of training the first machine learning model using the first dataset comprises:
inputting the first dataset into the CNN; and
processing, using the CNN, the first dataset to minimize or maximize an objective function for the CNN.

9. The computer-implemented method of claim 8, wherein the step of training the first machine learning model using the first dataset further comprises:
inputting the first dataset into the CNN;
predicting, using the CNN, the respective classifications for each of the plurality of tiles; and
obtaining the respective uncertainty measures for each of the plurality of tiles.

10. (canceled)

11. The computer-implemented method of claim 1, wherein the second machine learning model is a deep learning model.

12. The computer-implemented method of claim 11, wherein the deep learning model is a convolutional neural network (CNN), wherein the CNN comprises a plurality of fully connected layers and a plurality of dropout layers, wherein each of the plurality of dropout layers corresponds to a respective fully connected layer.

13. The computer-implemented method of claim 12, wherein the step of training the second machine learning model using the second dataset comprises:
inputting the second dataset into the CNN; and
processing, using the CNN, the second dataset to minimize or maximize an objective function for the CNN.

14. The computer-implemented method of claim 1, wherein the digital histology images are whole slide images.

15. (canceled)

16. The computer-implemented method of claim 14, wherein the whole slide images are images of tissue slices immunostained for different markers.

17. (canceled)

18. A computer-implemented method for classifying one or more tiles of a digital histology image using a machine learning model comprising:
deploying a machine learning model;
receiving a digital histology image;
extracting a plurality of tiles from the digital histology image;
inputting the plurality of tiles into the deployed machine learning model; and
outputting, using the deployed machine learning model, a respective classification, and a respective uncertainty measure for each of the plurality of tiles.

19. The computer-implemented method of claim 18, wherein the deployed machine learning model is a deep learning model.

20. The computer-implemented method of claim 19, wherein the deep learning model is a convolutional neural network (CNN), wherein the CNN comprises a plurality of fully connected layers and a plurality of dropout layers, wherein each of the plurality of dropout layers corresponds to a respective fully connected layer.

21. The computer-implemented method of claim 20, wherein the step of outputting, using the deployed machine learning model, the respective classification, and the respective uncertainty measure for each of the plurality of tiles comprises:
inputting each of the plurality of tiles into the CNN;
predicting, using the CNN, the respective classifications for each of the plurality of tiles; and
obtaining the respective uncertainty measures for each of the plurality of tiles.

22. The computer-implemented method of claim 21, wherein the step of obtaining the respective uncertainty measures for each of the plurality of tiles comprises using a Monte Carlo simulation.

23. The computer-implemented method of claim 18, further comprising generating a classification map for the digital histology image using the respective classifications and the respective uncertainty measures for each of the plurality of tiles output by the deployed machine learning model.

24. The computer-implemented method of claim 18, wherein the digital histology images are whole slide images.

25. (canceled)

26. The computer-implemented method of claim 24, wherein the whole slide image is an image of a tissue slice immunostained for different markers.

27. (canceled)

28. (canceled)
